(19) United States
(12) Patent Application Publication
(10) Pub. No.: US 2023/0344008 A1
(43) Pub. Date: Oct. 26, 2023

(54) CARBONATE ELECTROLYTE AND LITHIUM SECONDARY BATTERY CONTAINING SAME

(71) Applicants: Hyundai Motor Company, Seoul (KR); Kia Corporation, Seoul (KR)

(72) Inventors: Yeon Jong OH, Seoul (KR); Won Keun KIM, Seoul (KR); Eun Ji KWON, Yongin-si (KR); Kyu Ju KWAK, Hwaseong-si (KR); Dong Hyun LEE, Seoul (KR); Kyoung Han RYU, Yongin-si (KR); Samuel SEO, Yongin-si (KR)

(73) Assignees: Hyundai Motor Company, Seoul (KR); Kia Corporation, Seoul (KR)

(21) Appl. No.: 18/118,418

(22) Filed: Mar. 7, 2023

(30) Foreign Application Priority Data
Apr. 26, 2022 (KR) 10-2022-0051128

(51) Int. Cl. H01M 10/0568; H01M 10/0569; H01M 10/052

(52) U.S. Cl. CPC H01M 10/0568; H01M 10/0569; H01M 10/052; H01M 2300/0034; H01M 2300/0037

(57) ABSTRACT

Disclosed are a carbonate electrolyte and a lithium secondary battery including the same, in which the carbonate electrolyte includes a specific type of lithium salt at a high concentration equal to or greater than an appropriate level, thereby improving durability of the lithium secondary battery.

### CROSS-REFERENCE TO RELATED APPLICATION

The present application claims priority to Korean Patent Application No. 10-2022-0051128, filed on Apr. 26, 2022, the entire contents of which is incorporated herein for all purposes by this reference.

BACKGROUND OF THE PRESENT DISCLOSURE

### Field of the Present Disclosure

The present disclosure relates to a carbonate electrolyte and a lithium secondary battery including the same.

### Description of Related Art

Various techniques for battery materials are being developed to increase the durability, power output, stability, and energy density of lithium secondary batteries with lithium metal as an anode. In particular, thorough development of electrolyte compositions (salt type, salt concentration, solvent type, solvent ratio, additives, etc.) is ongoing in order to improve the characteristics of lithium secondary batteries.

Due to strong chemical and electrochemical side reactions with lithium metal, carbonate electrolytes have limitations in increasing durability when applied at low concentrations to lithium secondary batteries. Therefore, there is a need for an electrolyte capable of improving the durability of a lithium secondary battery by increasing lithium stability.

The information disclosed in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a carbonate electrolyte having improved durability and a lithium secondary battery including the same.

The objects of the present disclosure are not limited to the foregoing. The objects of the present disclosure will be able to be clearly understood through the following description and to be realized by the means described in the claims and combinations thereof.

The present disclosure provides a carbonate electrolyte including a lithium salt and a carbonate solvent, in which the lithium salt may include a first salt including at least one selected from the group consisting of LiFSI, LiFNFSI, LiTFSI, and combinations thereof, a second salt including at least one selected from the group consisting of LiBOB, LiDFOB, LiBF₄, and combinations thereof, and a third salt including LiPF₆, and the concentration of the lithium salt may be about 1.55 M to 3.15 M.

The concentration of the first salt may be about 1.2 M to 2.4 M.

The concentration of the second salt may be about 0.3 M to 0.6 M.

The concentration of the third salt may be about 0.05 M to 0.15 M.

The first salt may be LiFSI and the second salt may be LiDFOB.

The carbonate solvent may include at least one selected from the group consisting of ethylene carbonate (EC), ethyl methyl carbonate (EMC), dimethyl carbonate (DMC), diethyl carbonate (DEC), propylene carbonate (PC), vinyl ethylene carbonate (VEC), fluoroethylene carbonate (FEC), and combinations thereof

The carbonate solvent may include ethyl methyl carbonate (EMC) and fluoroethylene carbonate (FEC) in a volume ratio of about 2-4:1.

The carbonate solvent may include 65 vol % to 85 vol % of ethyl methyl carbonate (EMC) and 15 vol % to 35 vol % of fluoroethylene carbonate (FEC) based on the total volume of the carbonate solvent.

In addition, the present disclosure provides a lithium secondary battery including a cathode including a cathode active material, an anode including lithium metal, a separator interposed between the cathode and the anode, and the carbonate electrolyte described above incorporated into the separator.

The cathode active material may include at least one selected from the group consisting of LiCoO₂, Li(NiₓCo_{y}Mn_{z})O₂, Li(NiₓCo_{y}Al_{z})O₂, and combinations thereof (in which x, y, and z are real numbers that satisfy 0<x≤1, 0<y≤1, and 0<z≤1, respectively).

The lithium metal may have a thickness of about 10 μm to 200 μm.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a lithium secondary battery according to an exemplary embodiment of the present disclosure;

FIG. 2 shows results of measurement of viscosity of Examples and Comparative Examples;

FIG. 3 shows results of measurement of ionic conductivity of Examples and Comparative Examples;

FIG. 4 shows electrodeposition of Example 2;

FIG. 5 shows electrodeposition of Comparative Example 6;

FIG. 6 shows results of evaluation of battery characteristics of Example and Comparative Examples;

FIG. 7 shows results of evaluation of characteristics at the 5^{th} cycle of Li-NMC batteries to which Examples and Comparative Example are applied;

FIG. 8 shows results of evaluation of characteristics at the 40^{th} and 80^{th} cycles of Li-NMC batteries to which Examples and Comparative Example are applied;

FIG. 9 shows results of evaluation of lifespan characteristics of Li-NMC batteries to which Examples and Comparative Example are applied; and

FIG. 10 shows results of evaluation of lifespan characteristics of Li-NMC batteries to which Comparative Examples are applied.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments, it will be understood that the present description is not intended to limit the present disclosure(s) to those exemplary embodiments. On the contrary, the present disclosure(s) is/are intended to cover not only the exemplary embodiments, but also various alternatives, modifications, equivalents and other embodiments, which may be included within the spirit and scope of the present disclosure as defined by the appended claims.

of the present disclosure will be more clearly understood from the following exemplary embodiments taken in conjunction with the accompanying drawings. However, the present disclosure is not limited to the embodiments disclosed herein, and may be modified into different forms. These embodiments are provided to thoroughly explain the present disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in the present specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in the present specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

FIG. 1 is a cross-sectional view showing a lithium secondary battery according to an exemplary embodiment of the present disclosure. With reference thereto, the lithium secondary battery may include a cathode 10, an anode 20, and a separator 30 interposed between the cathode 10 and the anode 20. The lithium secondary battery may be impregnated with an electrolyte (not shown).

The cathode 10 may include a cathode active material, a binder, and a conductive material.

The cathode active material may include at least one selected from the group consisting of LiCoO₂, Li(NiₓCo_{y}Mn_{z})O₂, Li(NiₓCo_{y}Al_{z})O₂, and combinations thereof (in which x, y, and z are real numbers that satisfy 0<x≤1, 0<y≤1, and 0<z≤1, respectively). However, the cathode active material is not limited thereto, and any cathode active material available in the art may be used.

The binder is a component that assists in the bonding of the cathode active material and the conductive material and the bonding to a current collector, and may include polyvinylidene fluoride, polyvinyl alcohol, carboxymethyl cellulose (CMC), starch, hydroxypropyl cellulose, recycled cellulose, polyvinylpyrrolidone, tetrafluoroethylene, polyethylene, polypropylene, ethylene-propylene-diene terpolymer (EPDM), sulfonated EPDM, styrene butadiene rubber, fluororubber, various copolymers, and the like.

The conductive material is not particularly limited, so long as it has conductivity without causing a chemical change in the battery, and examples thereof may include graphite such as natural graphite or artificial graphite, carbon-based materials such as carbon black, acetylene black, Ketjen black, channel black, furnace black, lamp black, and summer black, conductive fiber such as carbon fiber or metal fiber, metal powder such as fluorocarbon, aluminum, and nickel powder, conductive whiskers such as zinc oxide and potassium titanate, conductive metal oxides such as titanium oxide, conductive materials such as polyphenylene derivatives, and the like.

The anode 20 may include lithium metal or a lithium metal alloy.

The lithium metal alloy may include an alloy of lithium and a metal or metalloid capable of alloying with lithium.

The metal or metalloid capable of alloying with lithium may include Si, Sn, Al, Ge, Pb, Bi, Sb, or the like.

The lithium metal has a large electric capacity per unit weight, which is advantageous for realizing a high-capacity battery.

The lithium metal may have a thickness of 10 μm to 200 μm. Here, if the thickness thereof is less than 10 μm, problems such as low battery lifespan may occur in a battery using lithium as an anode for a secondary battery. On the other hand, if the thickness thereof exceeds 200 μm, problems such as low energy density per weight of the battery may occur in a battery using lithium as an anode for a secondary battery.

The separator 30 is configured to prevent contact between the cathode 10 and the anode 20.

The separator 30 may be used without limitation, so long as it is commonly used in the field of the present disclosure to which the present disclosure belongs, and is, for example, made of a polyolefin material such as polypropylene (PP) or polyethylene (PE).

A carbonate electrolyte according to an exemplary embodiment of the present disclosure may include a lithium salt and a carbonate solvent.

In conventional carbonate electrolytes, the lithium salt is limited to a lithium salt having a fluorosulfonyl group, such as LiFSI, LiTFSI, or the like, which is an imide-based salt. In the present disclosure, however, the lithium salt includes a first salt, which is a conventional imide-based salt to improve the durability of lithium secondary batteries, a second salt, which is based on oxalatoborates capable of forming a nanoscale LiF anode film, and a third salt as a functional salt.

Conventional carbonate electrolytes have limitations in increasing durability when applied at low concentrations to lithium secondary batteries due to strong chemical and electrochemical side reactions with lithium metal. Accordingly, the present disclosure aims to improve the durability of a lithium secondary battery by virtue of the high-concentration effect when the concentration of the specific lithium salt is high in the carbonate solvent.

The first salt may be an imide-based salt and may include at least one selected from the group consisting of LiFSI, LiFNFSI, LiTFSI, and combinations thereof, having a fluorosulfonyl group. For example, the first salt may be LiFSI.

LiFSI and LiTFSI function to increase the conductivity of lithium ions.

The concentration of the first salt may be 1.2 M to 2.4 M. Here, if the concentration of the first salt is less than 1.2 M, there are a small number of lithium ions in the electrolyte, resulting in non-uniform lithium electrodeposition in lithium due to low ionic conductivity or decreased durability of the battery due to the presence of a deterioration factor such as a solvent. On the other hand, if the concentration thereof exceeds 2.4 M, non-uniform lithium electrodeposition may occur because of decreased wettability in the battery cathode due to high viscosity or lowered ionic conductivity due to decreased mobility of lithium ions.

The second salt may be an oxalatoborate-based salt capable of forming a nanoscale LiF anode film, and may include at least one selected from the group consisting of LiBOB, LiDFOB, LiBF₄, and combinations thereof. For example, the second salt may be LiDFOB.

LiDFOB also functions to increase lithium ionic conductivity through corrosion.

The concentration of the second salt may be 0.3 M to 0.6 M. Here, if the concentration of the second salt is less than 0.3 M, it is difficult to form a stable anode film due to a decrease in factors forming a nanoscale LiF film. On the other hand, if the concentration thereof exceeds 0.6 M, a decrease in ionic conductivity due to high viscosity and a failure to form a stable salt-solvent dissolution structure may occur.

The third salt may include LIPF₆ as a functional salt. LiPF₆ may effectively contribute to improving battery durability due to decreased Al corrosion during operation of a lithium secondary battery. Therefore, it is possible to obtain an effect of increasing the lifespan and energy density retention of the lithium secondary battery by improving the electrochemical stability.

The concentration of the third salt may be 0.05 M to 0.15 M. Here, if the concentration of the third salt is less than 0.05 M, Al corrosion cannot be prevented due to the absence of a sufficient amount of LiPF₆. On the other hand, if the concentration thereof exceeds 0.15 M, battery performance may be deteriorated due to HF in the presence of excess LiPF₆ due to formation of HF between LiPF₆ and water.

The concentration of the lithium salt may be 1.55 M to 3.15 M.

When the concentration of the lithium salt is high, the oxidation-reduction stability of the electrolyte, the electrolyte deterioration factor, and the stability of lithium metal may be effectively improved. However, at the same time, the ionic conductivity may be decreased and the viscosity may be increased, resulting in decreased electrode wetting. Accordingly, the present disclosure aims to improve electrochemical characteristics of a lithium secondary battery using a lithium salt at an appropriately high concentration.

The carbonate solvent may include at least one selected from the group consisting of ethylene carbonate (EC), ethyl methyl carbonate (EMC), dimethyl carbonate (DMC), diethyl carbonate (DEC), propylene carbonate (PC), vinyl ethylene carbonate (VEC), fluoroethylene carbonate (FEC), and combinations thereof. The carbonate solvent preferably includes ethyl methyl carbonate (EMC) and fluoroethylene carbonate (FEC).

The carbonate solvent may include ethyl methyl carbonate (EMC) and fluoroethylene carbonate (FEC) in a volume ratio of 2-4:1.

Here, if the volume ratio thereof is less than 2:1, an LiF film may be excessively formed during the charging reaction with lithium of the anode due to the presence of excess FEC, and as such, cell resistance may increase due to the thick film, deteriorating battery performance, which is undesirable. On the other hand, if the volume ratio thereof exceeds 4:1, LiF, known as a stable film in a lithium metal secondary battery, may not be formed in an appropriate amount due to the presence of a small amount of FEC, resulting in continuous side reactions between lithium and electrolyte and non-uniform SEI formation, shorting the battery.

The carbonate solvent may include 65 vol % to 85 vol % of ethyl methyl carbonate (EMC) and 15 vol % to 35 vol % of fluoroethylene carbonate (FEC) based on the total volume of the carbonate solvent. When FEC is used in a large amount compared to conventional techniques, a large amount of LiF may be formed due to high reducibility of lithium during operation of a lithium secondary battery, and the battery may operate based on a film formation mechanism different from that of a small amount of FEC.

A better understanding of the present disclosure may be obtained through the following examples and comparative examples. However, these examples are not to be construed as limiting the technical spirit of the present disclosure.

### Preparation Examples: Examples 1 to 3 and Comparative Examples 1 to 8

Respective carbonate electrolytes were prepared using components in the amounts shown in Table 1 below. Here, a solvent including ethyl methyl carbonate (EMC) and fluoroethylene carbonate (FEC) in a volume ratio of 3:1 was used.

TABLE 1

| | First salt | Second salt | Third salt |
|---|---|---|---|
| Example 1 | 1.2M LiTFSI | 0.3M LiDFOB | 0.075M LiFP₆ |
| Example 2 | 1.6M LiTFSI | 0.4M LiDFOB | 0.10M LiFP₆ |
| Example 3 | 2.4M LiTFSI | 0.6M LiDFOB | 0.15M LiFP₆ |
| Comparative | 0.2M LiDFOB | 0.14M LiBF₄ | — |
| Example 1 | | | |
| Comparative | 0.5M LiDFOB | 0.35M LiBF₄ | — |
| Example 2 | | | |
| Comparative | 1.0M LiDFOB | 0.70M LiBF₄ | — |
| Example 3 | | | |
| Comparative | 2.0M LiDFOB | 1.40M LiBF₄ | — |
| Example 4 | | | |
| Comparative | 0.4M LiTFSI | 0.1M LiDFOB | 0.025M LiFP₆ |
| Example 5 | | | |
| Comparative | 0.8M LiTFSI | 0.2M LiDFOB | 0.05M LiFP₆ |
| Example 6 | | | |
| Comparative | 0.8M LiTFSI | — | — |
| Example 7 | | | |
| Comparative | 1.6M LiTFSI | — | — |
| Example 8 | | | |

In the present disclosure, in order to compare the difference in characteristics depending on the salt type and salt concentration, carbonate electrolytes of different salt types and salt concentrations were prepared, and tests were conducted to evaluate the battery characteristics when using individual electrolytes.

### Test Example 1: Evaluation of Viscosity and Ionic Conductivity

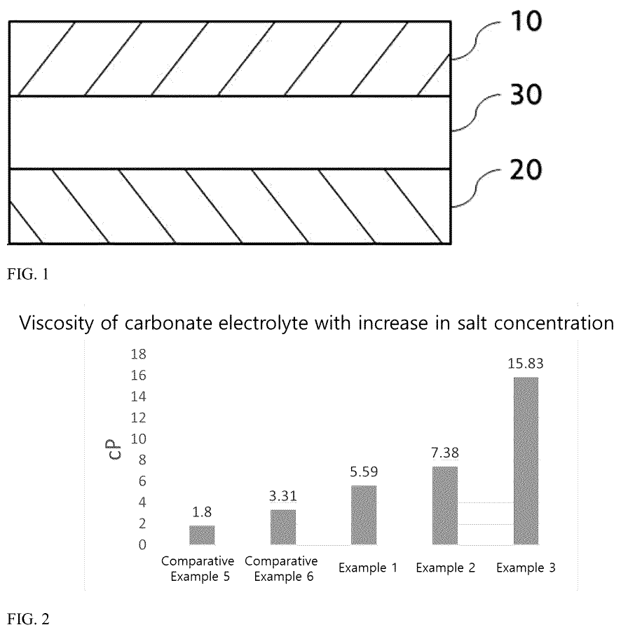

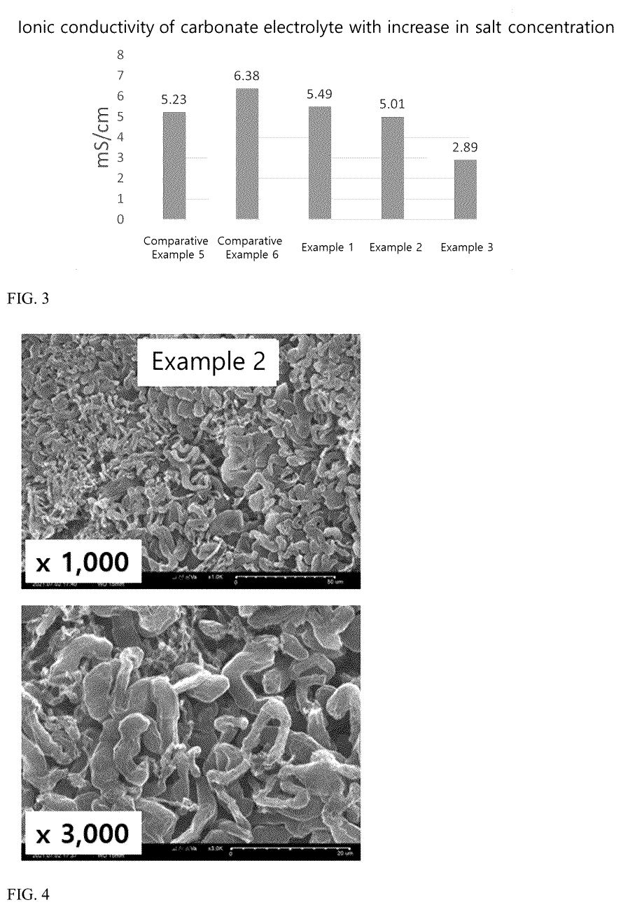

A test was conducted to evaluate the viscosity and ionic conductivity of the carbonate electrolytes prepared in Examples 1 to 3 and Comparative Examples 5 and 6. The results thereof are shown in Tables 2 and 3 below and in FIG. 2 and FIG. 3.

TABLE 2

| | Viscosity (cP) |
|---|---|
| Comparative Example 5 | 1.8 |
| Comparative Example 6 | 3.31 |
| Example 1 | 5.59 |
| Example 2 | 7.38 |
| Example 3 | 15.83 |

TABLE 3

| | Ionic Conductivity (mS/cm) |
|---|---|
| Comparative Example 5 | 5.23 |
| Comparative Example 6 | 6.38 |
| Example 1 | 5.49 |
| Example 2 | 5.01 |
| Example 3 | 2.89 |

Carbonate electrolytes are capable of causing strong chemical and electrochemical side reactions with lithium metal. Hence, low-concentration carbonate electrolytes limit the extent of increasing durability when applied to lithium metal batteries. Therefore, high-concentration electrolytes are required to increase the durability of a lithium metal battery by improving lithium stability.

When the electrolyte is used at a high concentration, the oxidation-reduction stability of the electrolyte may be increased, the electrolyte deterioration factor (free solvent) may be decreased, and the stability of lithium metal may be increased. However, since the high-concentration electrolyte decreases the ionic conductivity and increases the viscosity, problems such as decreased electrode wetting may occur. Since there is a trade-off between this increase and decrease, it is very important to set the high concentration in consideration thereof

FIG. 2 is a graph showing results of measurement of the viscosity of Examples and Comparative Examples. FIG. 3 is a graph showing results of measurement of the ionic conductivity of Examples and Comparative Examples. As shown in Table 2 and FIG. 2, the viscosity of the electrolyte was increased with an increase in the total concentration of the lithium salt even when using the same types of first salt, second salt, and third salt. This is deemed to be because the viscosity increases in proportion to the high concentration of the lithium salt, confirming a problem in that cathode wetting decreases with an increase in the viscosity.

However, as shown in Table 3 and FIG. 3, the ionic conductivity was decreased with an increase in the total concentration of the lithium salt, but was maintained at a substantially similar level.

In Examples 1 to 3, the viscosity was increased using the high-concentration electrolyte but the level of ionic conductivity that was decreased was not large.

### Test Example 2: Evaluation of Electrodeposition Depending on Salt Concentration

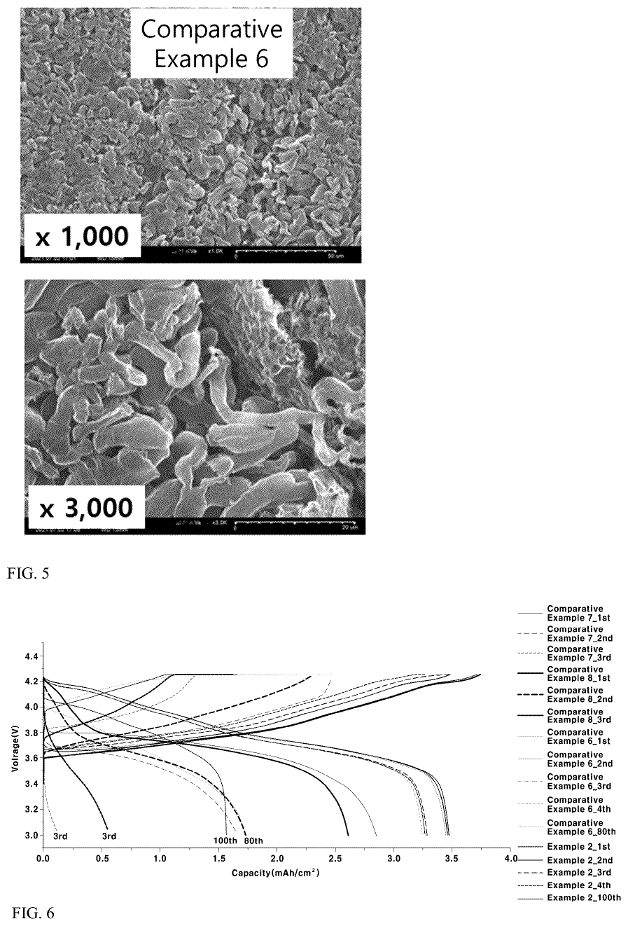

A test was conducted to evaluate electrodeposition depending on the salt concentration of the carbonate electrolytes prepared in Example 2 and Comparative Example 6. The results thereof are shown in FIG. 4 and FIG. 5.

FIG. 4 is images showing the electrodeposition of Example 2. FIG. 5 is images showing the electrodeposition of Comparative Example 6. As shown in FIG. 4 and FIG. 5, although the electrolyte concentration was higher in Example 2 than in Comparative Example 6, uniform electrodeposition was maintained, similar to Comparative Example 6, rather than non-uniform electrodeposition caused by lowered ionic conductivity due to decreased mobility of lithium ions.

### Test Example 3: Evaluation of Li-NMC Battery Characteristics Depending on Salt Composition

A test was conducted to evaluate the characteristics of Li-NMC batteries to which the carbonate electrolytes prepared in Example 2 and Comparative Examples 6 to 8 were applied. The results thereof are shown in FIG. 6.

FIG. 6 is a graph showing results of evaluation of the battery characteristics of Example and Comparative Examples. As shown in FIG. 6, the capacity of Comparative Example 7, which is a single composition of LiTFSI, was rapidly lowered after two cycles of charging and discharging during battery operation. Also, Comparative Example 8, which is a single composition of high-concentration LiTFSI, showed slightly more capacity, but the cell was deteriorated and terminated after 3 cycles of cell operation.

In contrast, in Comparative Example 6 to which the electrolyte containing three types of salts was applied, the Li-NMC cell was repeatedly/stably driven even after 3 cycles, and Example 2 to which the electrolyte containing three types of salts at high concentrations was applied also exhibited increased capacity.

For the Li-NMC battery to which the electrolyte containing the three types of salts was applied, the Li-NMC battery stably operated and 100 or more cycles of charging and discharging were stably performed.

### Test Example 4: Evaluation of Li-NMC Battery Characteristics Depending on Salt Concentration

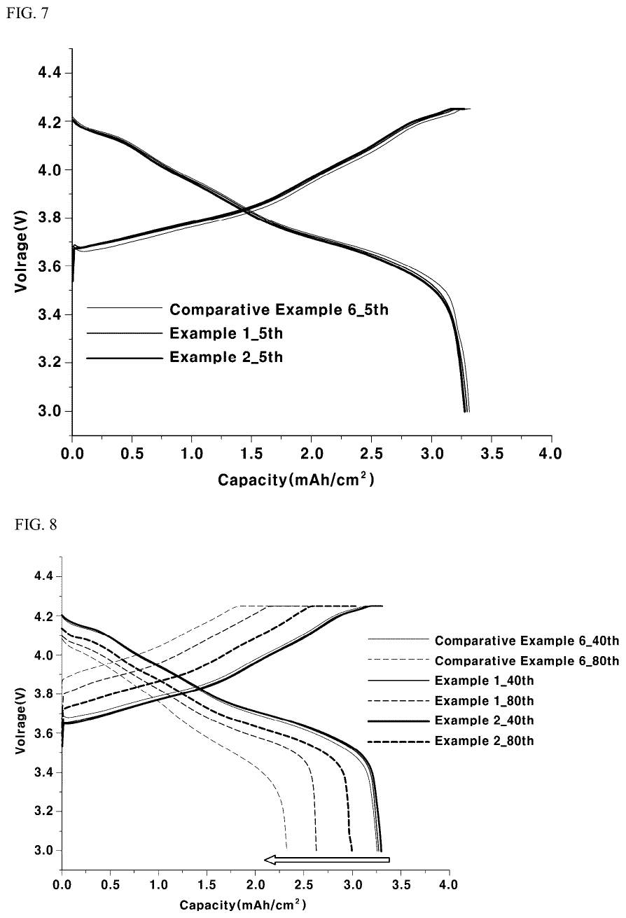

A test was conducted to evaluate the characteristics of the Li-NMC batteries to which the carbonate electrolytes prepared in Examples 1 and 2 and Comparative Example 6 were applied. The results thereof are shown in FIGS. 7, 8, and 9.

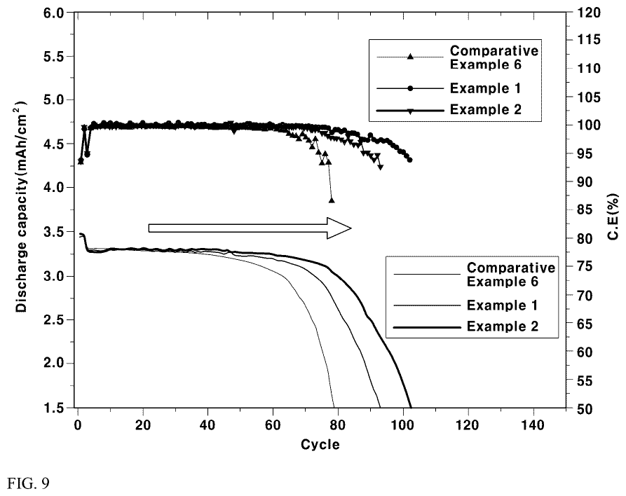

FIG. 7 is a graph showing results of evaluation of the characteristics at the 5^{th} cycle of Li-NMC batteries to which Examples and Comparative Example are applied. FIG. 8 is a graph showing results of evaluation of the characteristics at the 40^{th} and 80^{th} cycles of Li-NMC batteries to which Examples and Comparative Example are applied. FIG. 9 is a graph showing results of evaluation of the lifespan characteristics of Li-NMC batteries to which Examples and Comparative Example are applied.

As shown in FIG. 7, in Example 2 using the lithium salt at an appropriately high concentration compared to Comparative Example 6, the stability was increased and the viscosity was maintained at an appropriate level, and as such, the battery operated with similar discharge capacity at the 5^{th} cycle compared to Comparative Example 6 using the low-concentration lithium salt.

As shown in FIG. 8, in Comparative Example 6, when comparing the 40^{th} and 80^{th} cycles, the discharge capacity was decreased with an increase in overvoltage due to the decreased electrolyte stability and the increased resistance. In contrast, Example 2 operated with higher capacity than Comparative Example 6.

As shown in FIG. 9, when the overall lifespan measurement was performed, the battery durability was increased by about 27% or more in Example 2 compared to Comparative Example 6.

Therefore, in Example using the lithium salt at an appropriately high concentration, it can be confirmed that the discharge capacity and lifespan were improved compared to Comparative Example using the low-concentration lithium salt.

### Test Example 5: Evaluation of Li-NMC Battery Characteristics Depending on Salt Concentration in Electrolytes of Different Salt Combinations

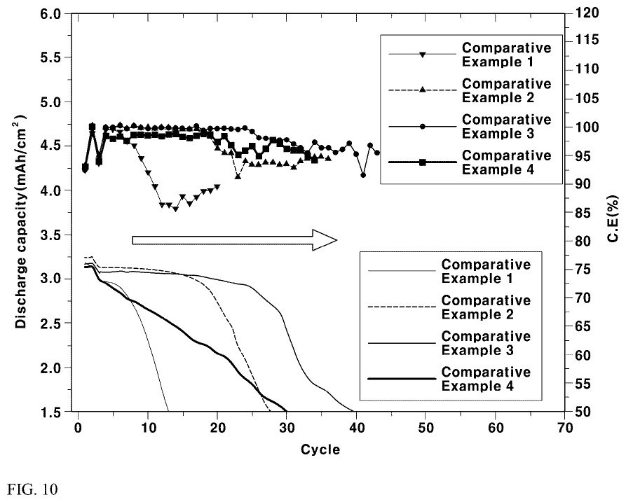

A test was conducted to evaluate the characteristics of Li-NMC batteries to which the carbonate electrolytes prepared in Comparative Examples 1 to 4 were applied. The results thereof are shown in FIG. 10.

FIG. 10 is a graph showing results of evaluation of the lifespan characteristics of Li-NMC batteries to which Comparative Examples are applied. As shown in FIG. 10, the durability of Comparative Examples 1 to 3, which is different from the salt combination of the present disclosure, was increased due to the use of the high-concentration lithium salt. Thereby, it can be confirmed that durability is increased when the concentration is raised up to a certain level even in other salt combinations, not the salt combination of the present disclosure.

However, in Comparative Example 4 using a higher concentration of lithium salt than Comparative Example 3, durability was decreased. This is deemed to be because the ionic conductivity is decreased and the viscosity is increased when the lithium salt is used at higher than a certain concentration.

Based on the results of Test Example 5, durability can be improved regardless of the combination of salts up to a certain level of high concentration, but applying a high concentration unconditionally does not improve durability. As in Examples of the present disclosure, it can be found that durability is increased only based on a specific lithium salt combination.

Accordingly, the carbonate electrolyte according to an exemplary embodiment of the present disclosure shows that durability of a lithium secondary battery can be maximally improved by including a specific type of lithium salt at a high concentration equal to or greater than an appropriate level.

As is apparent from the above description, a carbonate electrolyte according to an exemplary embodiment of the present disclosure is effective at increasing the oxidation-reduction stability of the electrolyte.

The carbonate electrolyte according to an exemplary embodiment of the present disclosure is effective at decreasing the deterioration factor (free solvent) of an electrolyte.

The carbonate electrolyte according to an exemplary embodiment of the present disclosure is effective at increasing lithium metal stability.

The effects of the present disclosure are not limited to the above-mentioned effects. It should be understood that the effects of the present disclosure include all effects that can be inferred from the description of the present disclosure.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. A carbonate electrolyte, comprising:
a lithium salt; and
a carbonate solvent,
wherein the lithium salt comprises a first salt comprising at least one selected from the group consisting of LiFSI, LiFNFSI, LiTFSI, and combinations thereof, a second salt comprising at least one selected from the group consisting of LiBOB, LiDFOB, LiBF₄, and combinations thereof, and a third salt comprising LiPF₆, and
wherein a concentration of the lithium salt is about 1.57 M to 3.15 M.

2. The carbonate electrolyte of claim 1, wherein a concentration of the first salt is about 1.2 M to 2.4 M.

3. The carbonate electrolyte of claim 1, wherein a concentration of the second salt is about 0.3 M to 0.6 M.

4. The carbonate electrolyte of claim 1, wherein a concentration of the third salt is about 0.07 M to 0.15 M.

5. The carbonate electrolyte of claim 1, wherein the first salt is LiFSI and the second salt is LiDFOB.

6. The carbonate electrolyte of claim 1, wherein the carbonate solvent comprises at least one selected from the group consisting of ethylene carbonate (EC), ethyl methyl carbonate (EMC), dimethyl carbonate (DMC), diethyl carbonate (DEC), propylene carbonate (PC), vinyl ethylene carbonate (VEC), fluoroethylene carbonate (FEC), and combinations thereof.

7. The carbonate electrolyte of claim 1, wherein the carbonate solvent comprises ethyl methyl carbonate (EMC) and fluoroethylene carbonate (FEC) in a volume ratio of about 2 to 4:1.

8. The carbonate electrolyte of claim 1, wherein the carbonate solvent comprises an amount of 65 vol % to 85 vol % of ethyl methyl carbonate (EMC) and an amount of 15 vol % to 35 vol % of fluoroethylene carbonate (FEC) based on a total volume of the carbonate solvent.

9. A lithium secondary battery, comprising:
a cathode comprising a cathode active material;
an anode comprising lithium metal;
a separator interposed between the cathode and the anode; and
the carbonate electrolyte of claim 1 incorporated into the separator.

10. The lithium secondary battery of claim 9,
wherein the cathode active material comprises at least one selected from the group consisting of LiCoO₂, Li(NiₓCo_{y}Mn_{z})O₂, Li(NiₓCo_{y}Al_{z})O₂, and combinations thereof,
wherein x, y, and z are real numbers that satisfy 0<x≤1, 0<y≤1, and 0<z≤1, respectively.

11. The lithium secondary battery of claim 9, wherein the lithium metal has a thickness of about 10 μm to 200 μm.

12. The lithium secondary battery of claim 9, wherein the lithium metal alloy includes an alloy of lithium and a metal or metalloid capable of alloying with the lithium.
